(19) United States
(12) Patent Application Publication
(10) Pub. No.: US 2026/0315965 A1
(43) Pub. Date: Oct. 15, 2026

(54) FILTER ASSEMBLY

(71) Applicant: LUMINOR Environmental Inc., Guelph (CA)

(72) Inventors: Taylor P. HANSEN, Eden Mills (CA); Michael P. SARCHESE, Guelph (CA)

(73) Assignee: LUMINOR Environmental Inc., Guelph (CA)

(21) Appl. No.: 19/641,741

(22) Filed: Apr. 8, 2026

Related U.S. Application Data
(60) Provisional application No. 63/789,115, filed on Apr. 15, 2025.

(51) Int. Cl. B01D 29/56; B01D 29/60; B01D 35/30; C02F 1/00

(52) U.S. Cl. CPC B01D 29/56; B01D 29/606; B01D 35/30; C02F 1/001; B01D 2201/303; B01D 2201/305; B01D 2201/347; B01D 2201/4038; B01D 2201/4046; B01D 2201/4092; C02F 2201/004; C02F 2201/006

(57) ABSTRACT

A filter assembly has a plurality of filter units and a mechanical connector fixed to the filter units to hold the filter units together in a defined spatial arrangement. Each filter unit has a sump head, a sump body releasably connected to the sump head, an outlet port, and an inlet port. The mechanical connector is fixed to the sump heads but not directly to the inlet ports and the outlet ports. The outlet port of a first filter unit is mated with the inlet port of a second filter unit in a non-mechanically-secured male/female relationship to form a fluid flow channel between the first and second sump heads. The non-mechanically-secured male/female relationship permits relative movement of the inlet port in the outlet port absent the mechanical connector.

### CROSS-REFERENCE TO RELATED APPLICATIONS

This application claims the benefit of USSN 63/789,115 filed Apr. 15, 2025, the entire contents of which is herein incorporated by reference.

### FIELD

This application relates to water treatment systems, in particular to an assembly of water filter units for treating water.

### BACKGROUND

Cartridge-based water treatment systems generally comprise multiple filter units for filtering different contaminants. Such systems intercept a waterline, so that water flows through the filter units in series before being delivered as clean, filtered water to equipment and fixtures subsequently connected thereto, for example a water heater or a faucet. Installation and maintenance of the filter units in the system requires assembling the filter units in series in manner whereby the connections between filter units are sealed to prevent leakage. Common methods of connecting neighboring filter units, such as mated threaded connections, quick release connections and the like can be problematic when assembling the filter units together due to difficulties in properly aligning and/or positioning inlet and outlet ports of neighboring filter units and/or in properly positioning a sealing element at the connection between the neighboring filter units. Typically, sealing connections between adjacent inlet and outlet ports is accomplished with a short, threaded pipe which leads to difficulty in achieving simultaneous alignment and sealing. Another disadvantage of such connecting and sealing arrangements is the possibility that one or more of the filter units are connected in reverse flow orientation with respect to an adjacent filter unit, thereby compromising the filter efficacy.

There remains a need for a filter assembly in which fluid connections between neighboring filter units can be properly made and sealed with reduced effort and with greater tolerance to separation of the fluid connections.

### SUMMARY

A filter assembly comprising a plurality of filter units through which a fluid to be treated flows and a mechanical connector fixed to the plurality of filter units to hold the plurality of filter units together in a defined spatial arrangement, the plurality of filter units comprising a first filter unit fluidly connected to a second filter unit, the first filter unit comprising a first sump head, a first sump body releasably connected to the first sump head, and an outlet port through which the fluid flows out of the first sump head, the second filter unit comprising a second sump head, a second sump body releasably connected to the second sump head, and an inlet port through which the fluid flows into the second sump head from the first sump head, the mechanical connector fixed to the first and second sump heads but not directly to the inlet port and the outlet port, the outlet port of the first filter unit mated with the inlet port of the second filter unit in a non-mechanically-secured male-port/female-port relationship to form a fluid flow channel between the first and second sump heads, the non-mechanically-secured male-port/female-port relationship permitting relative movement between the inlet port and the outlet port absent the mechanical connector, the fluid flow channel sealed from fluid leakage.

A filter assembly comprising a plurality of filter units through which a fluid to be treated flows and a mechanical connector fixed to the plurality of filter units to hold the plurality of filter units together in a defined spatial arrangement, each of the plurality of filter units comprising a sump head and a sump body releasably connected to the sump head, each of the sump heads having an inlet port through which the fluid flows into the sump head and an outlet port through which the fluid flows out of the sump head, the inlet port of a given sump head having a geometric design that only mates with a corresponding geometric design of the outlet port of another sump head to which the given sump head is to be connected in the defined spatial arrangement thereby preventing incorrect spatial arrangement of the filter units within the filter assembly, the mechanical connector fixed to each sump head but not directly to the inlet port or the outlet port of each sump head, the inlet port of the given sump head mated with the outlet port of the other sump head in a non-mechanically-secured relationship to form a fluid flow channel between the given sump head and the other sump head, the non-mechanically-secured relationship permitting relative movement between the inlet port of the given sump head and the outlet port of the other sump head absent the mechanical connector, the fluid flow channel sealed from fluid leakage.

A sump head for a cartridge-style filter unit, the sump head comprising an inlet port and an outlet port, wherein: one of the ports is unthreaded and another of the ports is threaded; or, both of the ports are unthreaded.

The term ‘non-mechanically-secured' means that the inlet port and the outlet port of the sump heads of neighboring filter units are not mechanically secured together directly by a mechanical connection dedicated only to that inlet port/outlet port pair. For example, the inlet port/outlet port pair is not matingly threaded and not rigidly pinned (e.g. not bolted) directly together. Thus, the inlet port/outlet port pair relies on a mechanical connector (e.g., clips, wires, brackets or the like) connected to the sump heads, but not directly to the inlet and outlet ports, to fix the inlet port and the outlet port in position when the mechanical connector is holding the sump heads of the neighboring filter units together in the defined spatial arrangement.

In some embodiments, the mechanical connector connected to the sump heads comprises one or more of a clip, a wire or a bracket. In some embodiments, the mechanical connector comprises an external holding bracket to which the plurality of filter units is fixed. In some embodiments, the external holding bracket comprises a plate comprising a plurality of securing elements arranged in a defined pattern that interact with a corresponding plurality of mated securing elements on the sump heads of the plurality of filter units to hold the plurality of filter units together in the defined spatial arrangement. In some embodiments, the plate is fixed to the sump heads over top of the sump heads.

In some embodiments, the plurality of securing elements comprises a plurality of threaded pins inserted through a plurality of apertures in the plate. In some embodiments, the corresponding plurality of mated securing elements on the sump heads comprises a plurality of internally threaded bosses that align with the plurality of apertures in the plate. In some embodiments, each of the plurality of internally threaded bosses is upwardly oriented. In some embodiments, each of the sump heads comprises two or more of the plurality of internally threaded bosses. In some embodiments, the corresponding plurality of mated securing elements on the sump heads comprises a plurality of externally threaded pins extending from the sump heads. In some embodiments, the plurality of securing elements comprises a plurality of apertures in the plate that align with the plurality of externally threaded pins. In some embodiments, a plurality of internally treaded fasteners (e.g., nuts) for the externally threaded pins are provided to secure the plate to the sump heads when the externally threaded pins are inserted through the plurality of apertures in the plate.

In some embodiments, the mechanical connector comprises vertically oriented flanges extending therefrom. In some embodiments, the vertically oriented flanges comprise features for interaction with ancillary components, for example hooks for hanging elements, apertures for insertion of pressure gauges, etc. In some embodiments, the filter assembly further comprises a hanging bracket secured to the mechanical connector for hanging the filter assembly on a surface. In some embodiments, the hanging bracket is secured to a vertically oriented flange of the mechanical connector. In some embodiments, the filter assembly further comprises one or more pressure taps. In some embodiments, the one or more pressure taps are equipped with one or more pressure gauges for measuring pressure in one or more of the sump heads. In some embodiments, the one or more pressure taps extend through a vertically oriented flange of the mechanical connector so that the pressure gauges can be fluidly connected to the pressure taps.

When assembling the filter assembly, the inlet port and the outlet port of neighboring filter units (e.g., on neighboring sump heads) may be initially mated by inserting the male port into the female port to create the fluid flow channel between the neighboring filter units. In some embodiments, the fluid flow channel is sealed by an annular seal between a radial external surface of the male port and a radial internal surface of the female port. In some embodiments, the annular seal comprises one or more O-rings. In some embodiments, the annular seal is seated in an annular groove around the radial external surface of the male port.

Because the inlet port is unthreaded and can move relative to the outlet port, which is also unthreaded, while still maintaining a seal, fixing the neighboring filter units (e.g., neighboring sump heads) together with the mechanical connector is more easily accomplished because there is movement tolerance for the sealed connection permitting the filter units to be moved into the defined spatial arrangement without breaking the seal in the fluid flow channel formed by the mated inlet and outlet ports. Thus, the filter assembly permits multiple filter units to be joined together in a manner that provides a liquid-tight seal between the filter units while still allowing relative movement between the filter units, for example rotational alignment of the sump heads. In addition, because the seal in the fluid flow channel has considerable movement tolerance without being broken, there is no necessity for the filter units to be exactly in the defined spatial arrangement and there is some tolerance for separation of neighboring filter units during operation of the filter assembly. For example, each of the neighboring filter units can be displaced by a distance at least up to the sum of all tolerances affecting the spatial positioning along the ports’ longitudinal axis while still maintaining a fluid seal in the fluid flow channel. In some embodiments, the distance is up to 2 mm.

The inlet and outlet ports are mated in a male/female relationship to form a fluid flow channel between neighboring filter units. In some embodiments, the male port is the outlet port one of the neighboring filter units. In some embodiments, the male port is the inlet port of one the neighboring filter units. In some embodiments, one of the ports is unthreaded. In some embodiments, another of the ports is threaded. In some embodiment, both of the ports are unthreaded. In some embodiments, one of the ports is unthreaded and is male and the other of the ports is threaded and is female. In some embodiments, one of the ports is unthreaded and is female and the other of the ports is threaded and is male. In some embodiments, one of the ports is unthreaded and is female and the other of the ports is threaded and female. In some embodiments, both of the ports are unthreaded and are male. In some embodiments, both of the ports are unthreaded and are female. In some embodiments, the inlet port is unthreaded and the outlet port is threaded. In some embodiments, the outlet port is unthreaded and the inlet port is threaded. Preferably, the geometric design relationship of the male/female ports prevents reverse assembly of one or more filter units (e.g., prevents the outlet of the second filter unit from mating with the outlet of the first filter unit because such reverse assembly is detrimental to filter performance). For example, the outlet port of the male/female pair can be the male port, which also better facilitates fluid flow from one of the filter units to the neighboring filter unit.

In some embodiments, when assembling the filter assembly, the non-mechanically-secured male-port/female-port relationship is provided by a fitting. In some embodiments, the fitting has a first portion that is secured to the outlet port of the first filter unit (e.g., on a sump head of the first filter unit) and a second portion that is secured to the inlet port of the second filter unit (e.g., on a sump head of the second filter unit). In some embodiments, the first portion of the fitting is separably mated with the second portion of the fitting in the non-mechanically-secured male-port/female-port relationship. In some embodiments, the first portion is mechanically secured (e.g., through mated threads, clips or the like) to the outlet port of the first filter unit. In some embodiments, the second portion is mechanically secured (e.g., through mated threads, clips or the like) to the inlet port of the second filter unit. When the non-mechanically-secured male-port/female-port relationship is provided by the fitting, the fluid flow channel may be sealed by an annular seal between a radial external surface of the male port and a radial internal surface of the female port. The male port may be on the first or second portion of the fitting. When the male port is on the first portion of the fitting, the female port is on the second portion of the fitting. When the male port is on the second portion of the fitting, the female port is on the first portion of the fitting. When the fitting is used, the filter assembly enjoys all the same benefits of movement tolerance as described above.

The filter assembly can comprise any number of filter units fluidly connected together, preferably in series. In some embodiments, the filter assembly comprises 2, 3, 4, 5, 6 or more filter units. Any one or more of each pair of neighboring filter units may have the non-mechanically-secured male-port/female-port relationship therebetween. In some embodiments, all pairs of neighboring filter units have the non-mechanically-secured male-port/female-port relationship therebetween. In some embodiments, all the non-mechanically-secured male-port/female-port relationships are not provided by a fitting. In some embodiments, all the non-mechanically-secured male-port/female-port relationships are provided by a fitting. In some embodiments, at least one of the non-mechanically-secured male-port/female-port relationships is provided by a fitting and at least one of the non-mechanically-secured male-port/female-port relationships is not provided by a fitting.

In some embodiments, the filter assembly is a water treatment system for purifying water, especially drinking water.

Further features will be described or will become apparent in the course of the following detailed description. It should be understood that each feature described herein may be utilized in any combination with any one or more of the other described features, and that each feature does not necessarily rely on the presence of another feature except where evident to one of skill in the art.

### BRIEF DESCRIPTION OF THE DRAWINGS

For clearer understanding, preferred embodiments will now be described in detail by way of example, with reference to the accompanying drawings, in which:

FIG. 1 depicts an exploded perspective view of a filter assembly.

FIG. 2 depicts an exploded front view of the filter assembly of FIG. 1.

FIG. 3A depicts a front view of the filter assembly of FIG. 1 when assembled.

FIG. 3B depicts a rear view of the filter assembly of FIG. 3A.

FIG. 3C depicts a left-side view of the filter assembly of FIG. 3A.

FIG. 3D depicts a right-side view of the filter assembly of FIG. 3A.

FIG. 3E depicts a top view of the filter assembly of FIG. 3A.

FIG. 3F depicts a bottom view of the filter assembly of FIG. 3A.

FIG. 4A depicts an enlarged view of FIG. 3E.

FIG. 4B depicts a front section view through A-A of FIG. 4A.

FIG. 5 depicts an enlarged view of FIG. 3B with a hanging bracket removed.

FIG. 6A depicts a top perspective view of a sump head.

FIG. 6B depicts a bottom perspective view of the sump head of FIG. 6A.

FIG. 7A depicts a front isometric view of an alternate embodiment of an assembled filter assembly utilizing separable fittings between sump heads.

FIG. 7B depicts a front view of the filter assembly of FIG. 7A.

FIG. 7C depicts a front section view of the filter assembly of FIG. 7A.

FIG. 7D depicts a magnified view of area B in FIG. 7C.

FIG. 7E depicts an exploded view of the filter assembly of FIG. 7A.

FIG. 7F depicts an exploded view of the sump heads of the filter assembly of FIG. 7A.

FIG. 7G depicts a magnified view of area C in FIG. 7F.

### DETAILED DESCRIPTION

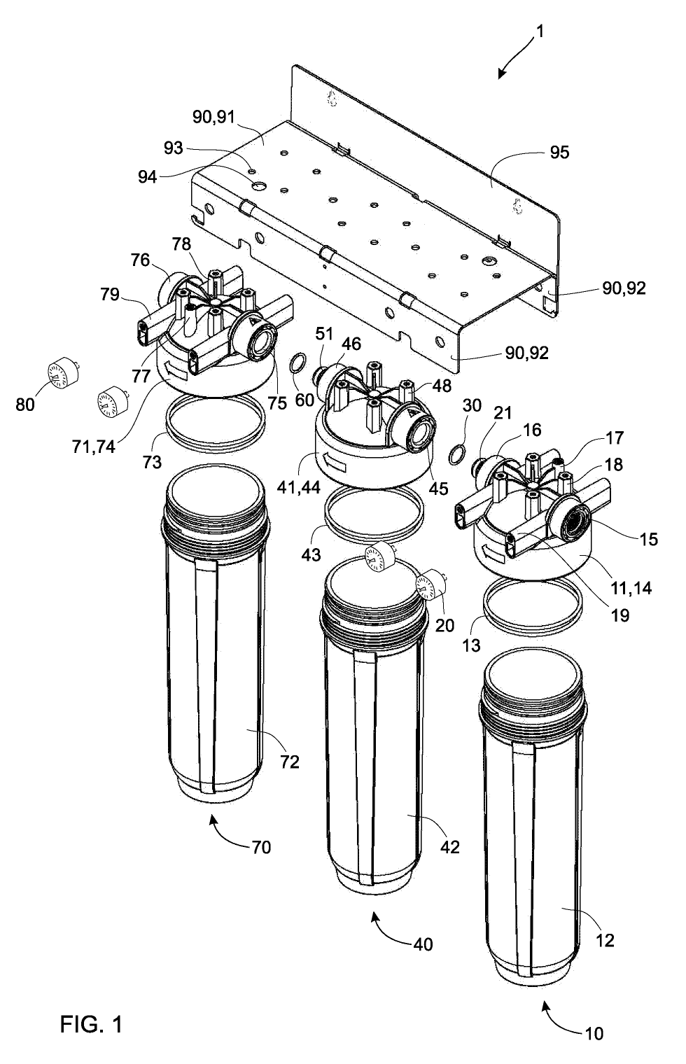

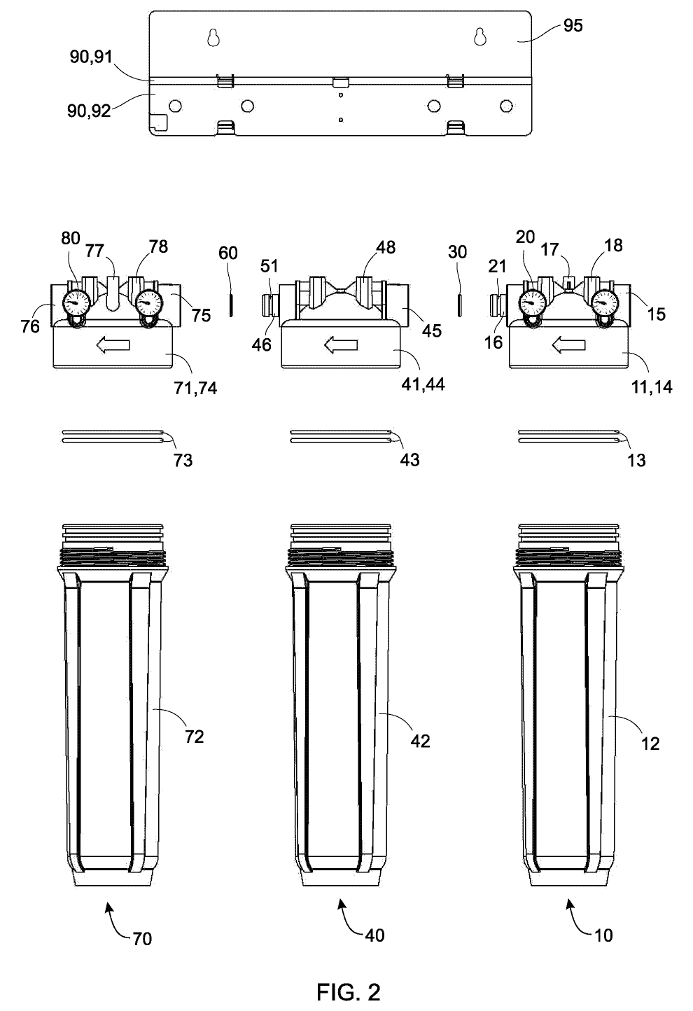

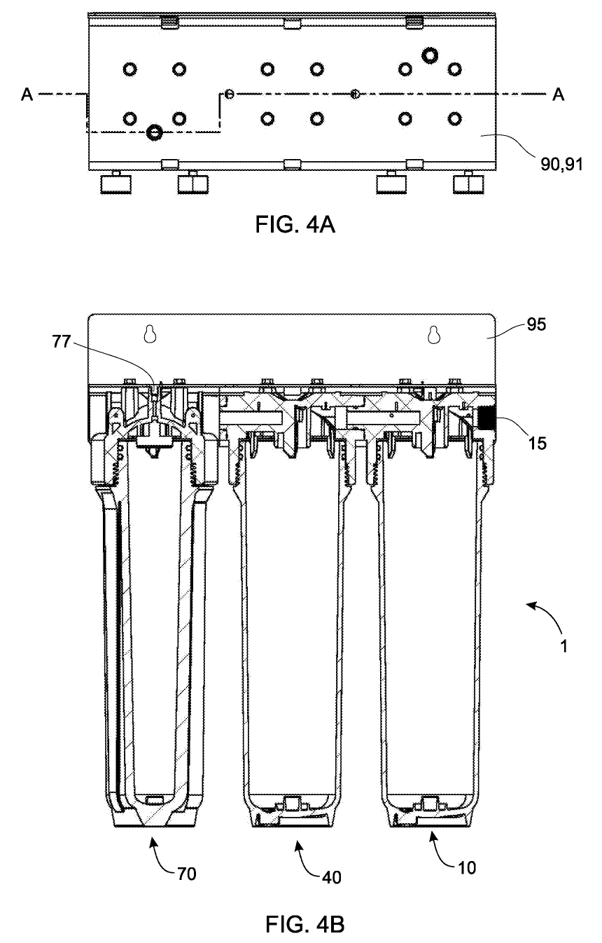

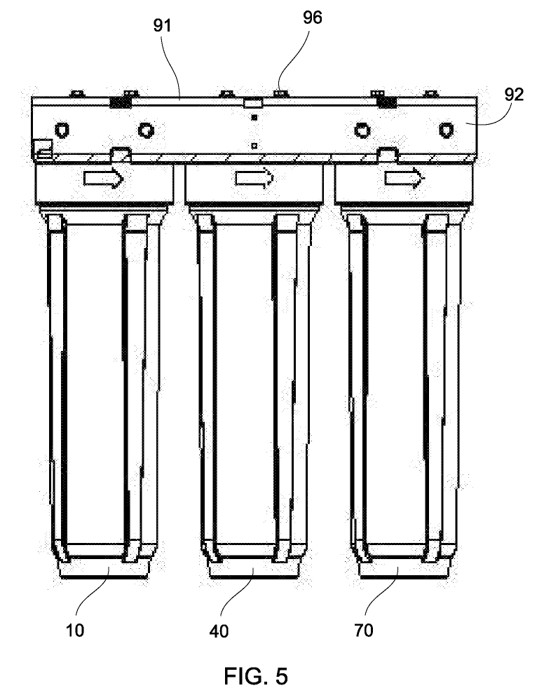

With reference to FIGS. 1 to 6B, a filter assembly 1 for water purification comprises three filter units fluidly connected in series so that water flows through a first filter unit 10, then through a second filter unit 40 and then through a third filter unit 70 before exiting the filter assembly 1. The first filter unit 10 comprises a first sump head 11 having a first sump body 12 threadingly connected to the first sump head 11 below the first sump head 11 with sealing gaskets 13 disposed between adjacent sealing surfaces on the first sump head 11 and the first sump body 12. Likewise, the second filter unit 40 comprises a second sump head 41 having a second sump body 42 threadingly connected to the second sump head 41 below the second sump head 41 with sealing gaskets 43 disposed between adjacent sealing surfaces on the second sump head 41 and the second sump body 42. Likewise, the third filter unit 70 comprises a third sump head 71 having a third sump body 72 threadingly connected to the third sump head 71 below the third sump head 71 with sealing gaskets 73 disposed between adjacent sealing surfaces on the third sump head 71 and the third sump body 72.

As is standard for many water filtration systems, water filter cartridges are provided in the sumps of each filter unit so that water flowing into a filter unit flows into the sump head, down into the sump body, then through the filter and up a conduit to the sump head, and then out from the sump head. Direction of water flow through the filter assembly 1 is shown by large arrows molded into the sump heads.

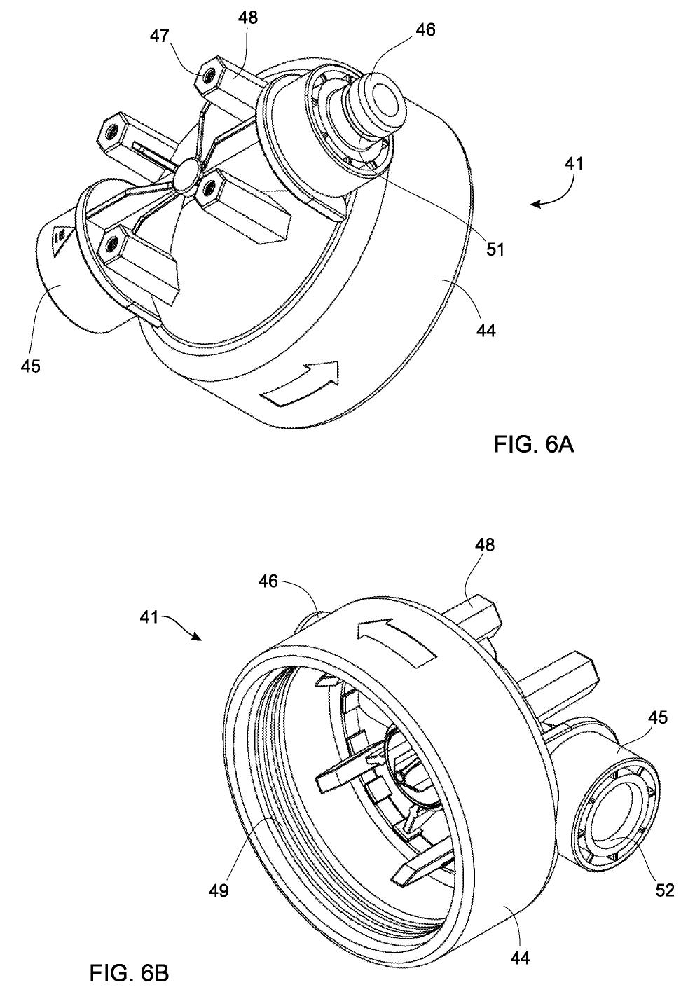

The sump heads 11, 41, 71 are of similar construction with some variations. While FIGS. 6A and 6B particularly illustrate the second sump head 41, FIGS. 6A and 6B also illustrate the nature of common features between all the sump heads 11, 41, 71.

The first sump head 11 comprises a cylindrical portion 14 that comprises internal threads for mating connection to external threads on the first sump body 12. The first sump head 11 comprises a first inlet port 15 to provide fluid connection to a plumbing system and comprises an unthreaded first outlet port 16 to provide fluid connection to the second filter unit 40. The first outlet port 16 is a male port comprising a conduit having a radial external surface around which an annular groove 21 is provided for seating an O-ring 30. The first sump head 11 further comprises a first pressure vent 17 with an openable plug to vent air from any of the filter units 10, 40, 70. The first sump head 11 further comprises four upwardly extending mounting bosses 18 (only one labeled), each having an internal thread into which externally bolts 96 can be engaged to secure the first filter unit 10 to an external holding bracket 90. The first sump head 11 further comprises four pressure taps 19 (only one of four labeled), two extending frontward and two extending rearward. The pressure taps 19 can either be plugged when not in use or have pressure gauges 20 (only one of two labeled) connected thereto to measure pressure at the first inlet port 15 and the first outlet port 16. Having pressure taps 19 extending both frontward and rearward permits reversing the mounting configuration while enjoying the same functionality in both configurations.

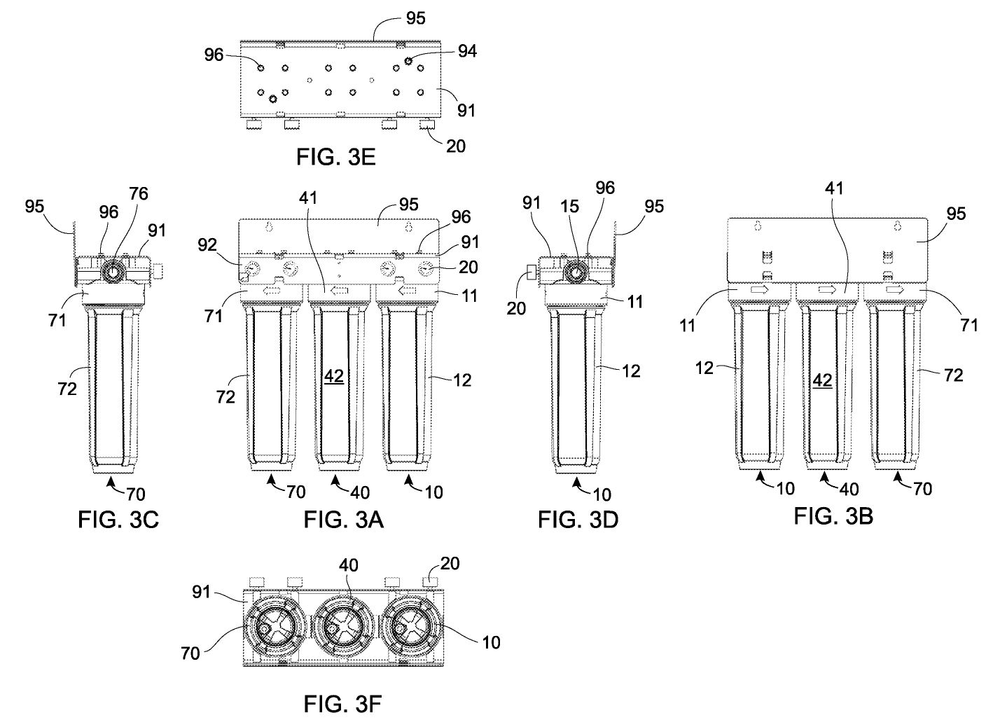

The second sump head 41, which is particularly shown in FIGS. 6A and 6B, comprises a cylindrical portion 44 that comprises internal threads 49 for mating connection to external threads on the second sump body 42. The second sump head 41 comprises an unthreaded second inlet port 45 to provide fluid connection to the first filter unit 10 and comprises an unthreaded second outlet port 46 to provide fluid connection to the third filter unit 70. The second inlet port 45 is a female port into which the first outlet port 16 of the first filter unit 10 is inserted during assembly. The second inlet port 45 comprises an internal radial surface 52 that engages the O-ring 30 seated in the annular groove 21 of the first outlet port 16. A sealed connection between the first outlet port 16 and the second inlet port 45 is maintained by the O-ring 30 over a length of the internal radial surface 52 of the second inlet port 45 providing tolerance for the relative positioning of the first and second filter units 10, 40 while maintaining a seal against leakage of water at the connection between the first and second filter units 10, 40. The second outlet port 46 is a male port comprising a conduit having a radial external surface around which an annular groove 51 is provided for seating an O-ring 60. The second sump head 41 further comprises four upwardly extending mounting bosses 48 (only one labeled), each having an internal thread 47 (only one labeled) into which the externally threaded bolts 96 (only one shown in FIGS. 3A. 3C, 3D and 3E) can be engaged to secure the second filter unit 40 to the external holding bracket 90.

The third sump head 71 comprises a cylindrical portion 74 that comprises internal threads for mating connection to external threads on the third sump body 72. The third sump head 71 comprises an unthreaded third inlet port 75 to provide fluid connection to the second filter unit 40 and comprises third outlet port 76 to provide fluid connection to the plumbing system. The third inlet port 75 is a female port into which the second outlet port 46 of the second filter unit 40 is inserted during assembly. The third inlet port 75 comprises an internal radial surface that engages the O-ring 60 seated in the annular groove 51 of the second outlet port 46. A sealed connection between the second outlet port 46 and the third inlet port 75 is maintained by the O-ring 60 over a length of the internal radial surface of the third inlet port 75 providing tolerance for the relative positioning of the second and third filter units 40, 70 while maintaining a seal against leakage of water at the connection between the second and third filter units 40, 70. The third sump head 71 further comprises another pressure vent 77 with an openable plug to vent air from any of the filter units 10, 40, 70. The third sump head 71 further comprises four upwardly extending mounting bosses 78 (only one labeled), each having an internal thread into which the externally threaded bolts 96 can be engaged to secure the third filter unit 70 to the external holding bracket 90. The third sump head 71 further comprises four pressure taps 79 (only one of four labeled), two extending frontward and two extending rearward. The pressure taps 79 can either be plugged when not in use or have pressure gauges 80 (only one of two labeled) connected thereto to measure pressure at the third inlet port 75 and the third outlet port 76. Having pressure taps 79 extending both frontward and rearward permits reversing the mounting configuration while enjoying the same functionality in both configurations.

The external holding bracket 90 is in the form of a C-channel comprising a horizontally oriented plate 91 and a pair of flanges 92 downwardly extending from opposed front and rear edges of the plate 91. The plate 91 comprises an array of through-apertures 93 (only one of twelve labeled) arranged in a pattern so that the through-apertures can be aligned with the mounting bosses 18, 48, 78 extending upwardly from the sump heads 11, 41, 71. The bolts 96 (only one of twelve labeled) inserted through the through-apertures 93 engage the threaded bosses of the mounting posts 18, 48, 78 to fix the sump heads 11, 41, 71 to the external holding bracket 90 in a defined spatial arrangement. The plate 91 also comprises vent holes 94 (only one of two labeled) that align with the pressure vents 17, 77 when the first and third filter units 10, 70 are connected to the external holding bracket 90.

The external holding bracket 90 provides the only mechanical securement to prevent relative motion between the filter units 10, 40, 70 of the filter assembly 1 along an axis parallel to the longitudinal axis of the engaged and sealed port pairs 16, 45 and 46, 75, and to prevent relative rotational movement around the longitudinal axis of the engaged port pairs. Without the external holding bracket 90 or other securing means, internal water pressure could cause the pairs of sealing ports 16, 45 and 46, 75 to move apart from each other to an extent that the O-rings 30 and 60 would disengage from the sealing surfaces of their respective inlet ports 45 and 75, thereby compromising their respective fluid-tight sealing properties.

A mounting bracket 95 is removably connected to and extends upwardly from one of the flanges 92 of the external holding bracket 90. The mounting bracket 95 is removable and can be connected to either of the flanges 92, for example by clips, to permit reversing the mounting configuration while enjoying the same functionality in both configurations. The mounting bracket 95 permits mounting the filter assembly 1 on a surface, for example a vertical surface such as a wall.

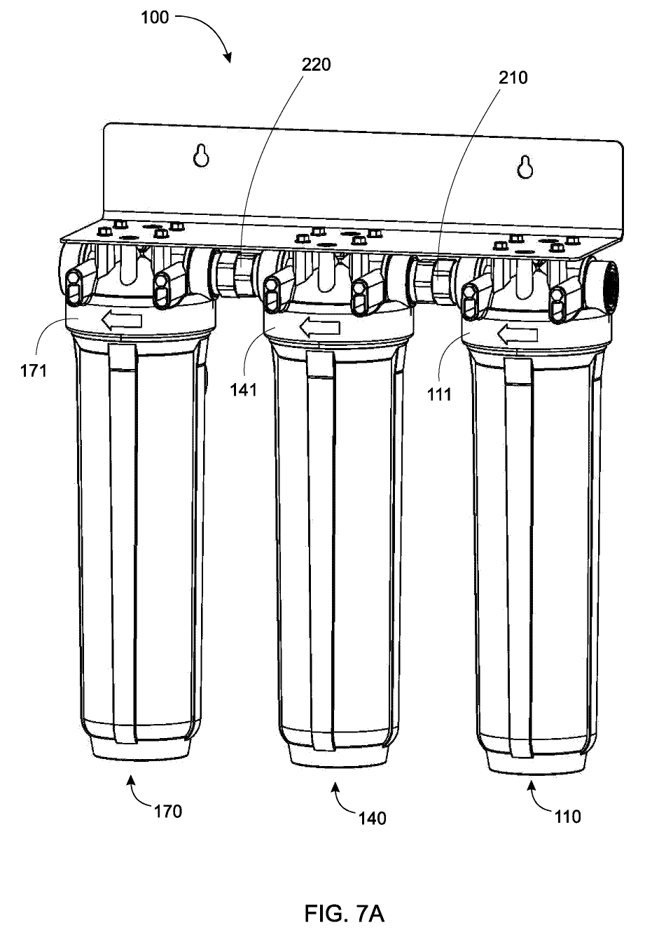

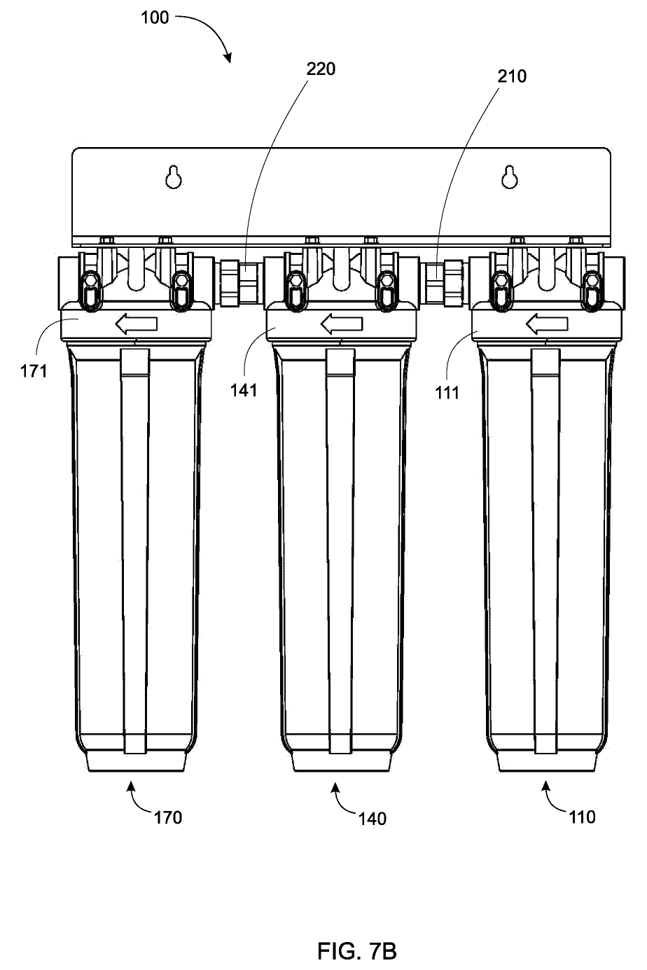

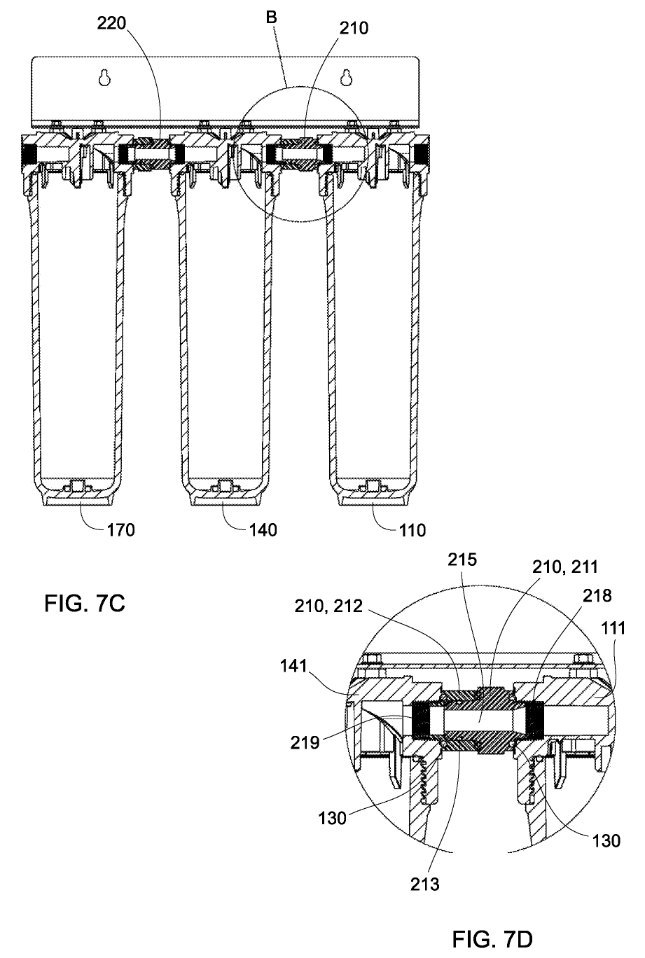

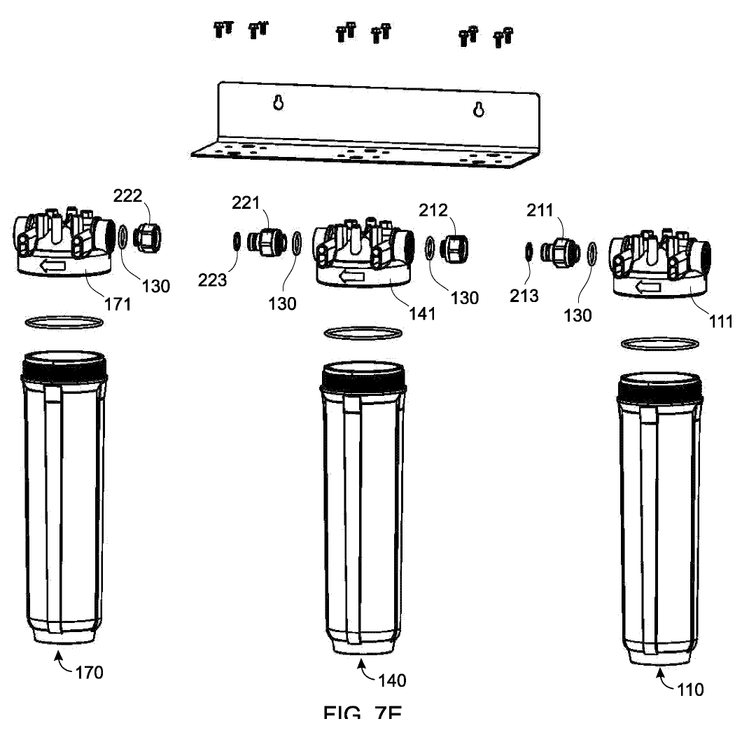

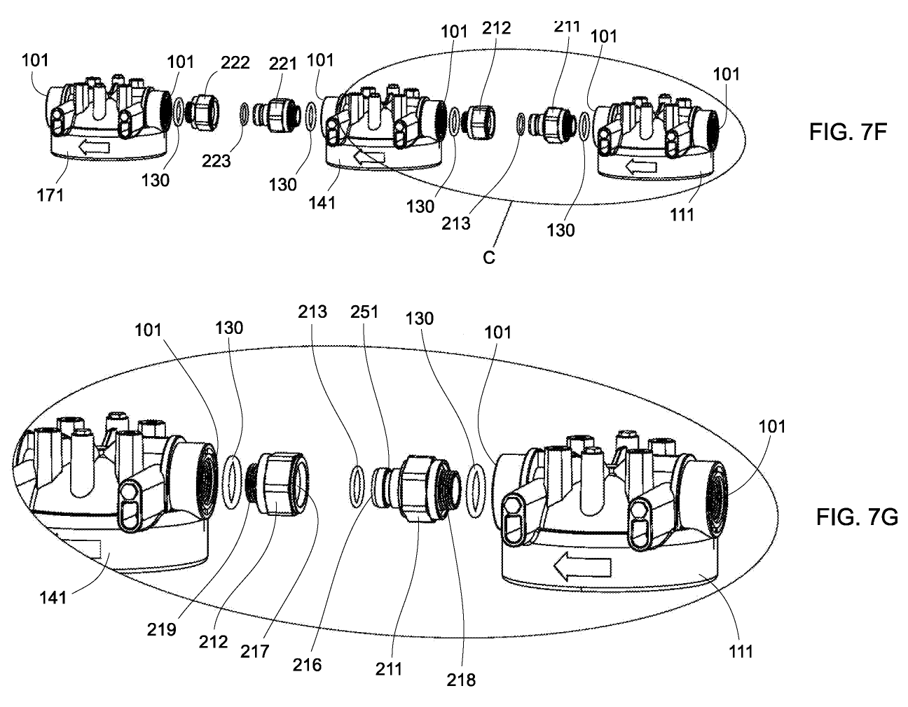

With reference to FIGS. 7A to 7G, a filter assembly 100 is substantially the same as the filter assembly 1 except that the filter assembly 100 comprises filter units 110, 140 and 170 having sump heads 111, 141 and 171 where each of the sump heads 111, 141 and 171 have standard threaded female inlet and outlet ports 101 and the filter assembly 100 comprises first and second separable fittings 210 and 220, respectively, to provide the non-mechanically-secured male-port/female-port relationships between the sump heads 111, 141 and 171. The first fitting 210 comprises a first portion 211 and a second portion 212, which are releasably couplable together to form the first fitting 210. Likewise, the second fitting 220 comprises a first portion 221 and a second portion 222, which are releasably couplable together to form the second fitting 220 (see FIGS. 7E to 7G).

The first fitting 210 is a separable fitting meaning that the first portion 211 and the second portion 212 of the first fitting 210 are releasably couplable together in the non-mechanically-secured male-port/female-port relationship. In the illustrated embodiment, the first portion 211 comprises a male port 216 with a conduit (see FIG. 7G) and the second portion 212 comprises a female port 217 with a conduit, the male port 216 insertable into the female port 217 to form a fluid flow channel 215 (see FIG. 7D) through the first fitting 210. In some embodiments, the first portion comprises the female port and the second portion comprises a male port, i.e., the port configurations may be reversed. The male port 216 comprises a conduit having a radial external surface around which an annular groove 251 is provided for seating an O-ring 213, which helps seal the fluid flow channel 215. The first portion 211 of the first fitting 210 comprises a threaded male port 218 for threaded connection to one of the threaded female ports 101 on the sump head 111 while the second portion 212 of the first fitting 210 also comprises a threaded male port 219 for threaded connection to one of the threaded female ports 101 on the sump head 141. Face seals 130 may be used to seal the connections between the first fitting 210 and the sump heads 111 and 141. The arrangement of the first portion 211 and the second portion 212 of the first fitting 210 provides the non-mechanically-secured male-port/female-port relationship between the sump head 111 and the sump head 141. The second fitting 220 is constructed and works similarly to the first fitting 210 to provide the non-mechanically-secured male-port/female-port relationship between the sump head 141 and the sump head 171, an O-ring 223 helping seal the fluid flow channel in the second fitting 220.

The novel features will become apparent to those of skill in the art upon examination of the description. It should be understood, however, that the scope of the claims should not be limited by the embodiments but should be given the broadest interpretation consistent with the wording of the claims and the specification as a whole.

1. A filter assembly comprising a plurality of filter units through which a fluid to be treated flows and a mechanical connector fixed to the plurality of filter units to hold the plurality of filter units together in a defined spatial arrangement,
the plurality of filter units comprising a first filter unit fluidly connected to a second filter unit,
the first filter unit comprising a first sump head, a first sump body releasably connected to the first sump head, and an outlet port through which the fluid flows out of the first sump head,
the second filter unit comprising a second sump head, a second sump body releasably connected to the second sump head, and an inlet port through which the fluid flows into the second sump head from the first sump head,
the mechanical connector fixed to the first and second sump heads but not directly to the inlet port and the outlet port,
the outlet port of the first filter unit mated with the inlet port of the second filter unit in a non-mechanically-secured male-port/female-port relationship to form a fluid flow channel between the first and second sump heads, the non-mechanically-secured male-port/female-port relationship permitting relative movement between the inlet port and the outlet port absent the mechanical connector, the fluid flow channel sealed from fluid leakage.

2. The filter assembly of claim 1, wherein the fluid flow channel is sealed by an annular seal between a radial external surface of the male port and a radial internal surface of the female port.

3. The filter assembly of claim 2, wherein the annular seal comprises an O-ring seated in an annular groove around the radial external surface of the male port.

4. The filter assembly of claim 1, wherein the mechanical connector comprises one or more of a clip, a wire or a bracket.

5. The filter assembly of claim 4, wherein the mechanical connector comprises an external holding bracket to which the plurality of filter units is fixed.

6. The filter assembly of claim 5, wherein the external holding bracket comprises a plate comprising a plurality of securing elements arranged in a defined pattern that interact with a corresponding plurality of mated securing elements on the sump heads of the plurality of filter units to hold the plurality of filter units together in the defined spatial arrangement.

7. The filter assembly of claim 6, wherein the plate is fixed to the sump heads over top of the sump heads.

8. The filter assembly of claim 6, wherein the plurality of securing elements comprises a plurality of externally threaded pins inserted through a plurality of apertures in the plate, and the corresponding plurality of mated securing elements on the sump heads comprises a plurality of internally threaded bosses that align with the plurality of apertures in the plate.

9. The filter assembly of claim 8, wherein each of the plurality of internally threaded bosses is upwardly oriented and each of the sump heads comprises two or more of the plurality of internally threaded bosses.

10. The filter assembly of claim 6, wherein the corresponding plurality of mated securing elements on the sump heads comprises a plurality of externally threaded pins extending from the sump heads, and the plurality of securing elements comprises a plurality of apertures in the plate that align with the plurality of threaded pins and a plurality of internally threaded fasteners for the threaded pins to secure the plate to the sump heads when the threaded pins are inserted through the plurality of apertures in the plate.

11. The filter assembly of claim 1, wherein the male port is the outlet port of the first filter unit.

12. The filter assembly of claim 1, wherein the male port is the inlet port of the second filter unit.

13. The filter assembly of claim 1, wherein the non-mechanically-secured male-port/female-port relationship is provided by a fitting, the fitting having a first portion that is secured to the outlet port of the first filter unit and a second portion that is secured to the inlet port of the second filter unit, the first portion of the fitting separably mated with the second portion of the fitting in the non-mechanically-secured male-port/female-port relationship.

14. The filter assembly of claim 1, further comprising a hanging bracket secured to the external holding bracket for hanging the filter assembly on a surface.

15. The filter assembly of claim 1, further comprising one or more pressure taps, equipped with one or more pressure gauges for measuring pressure in one or more of the sump heads.

16. The filter assembly of claim 1, wherein the plurality of filter units comprises at least three filter units fluidly connected in series, wherein each pair of neighboring filter units have the non-mechanically-secured male-port/female-port relationship therebetween.

17. The filter assembly of claim 1, wherein the fluid is water.

18. A filter assembly comprising a plurality of filter units through which a fluid to be treated flows and a mechanical connector fixed to the plurality of filter units to hold the plurality of filter units together in a defined spatial arrangement,
each of the plurality of filter units comprising a sump head and a sump body releasably connected to the sump head,
each of the sump heads having an inlet port through which the fluid flows into the sump head and an outlet port through which the fluid flows out of the sump head,
the inlet port of a given sump head having a geometric design that only mates with a corresponding geometric design of the outlet port of another sump head to which the given sump head is to be connected in the defined spatial arrangement thereby preventing incorrect spatial arrangement of the filter units within the filter assembly,
the mechanical connector fixed to each sump head but not directly to the inlet port or the outlet port of each sump head,
the inlet port of the given sump head mated with the outlet port of the other sump head in a non-mechanically-secured relationship to form a fluid flow channel between the given sump head and the other sump head, the non-mechanically-secured relationship permitting relative movement between the inlet port of the given sump head and the outlet port of the other sump head absent the mechanical connector, the fluid flow channel sealed from fluid leakage.

19. A sump head for a cartridge-style filter unit, the sump head comprising an inlet port and an outlet port, wherein:
one of the ports is unthreaded and another of the ports is threaded; or,
both of the ports are unthreaded.

20. The sump head of claim 19, wherein:
one of the ports is unthreaded and is male and the other of the ports is threaded and is female;
one of the ports is unthreaded and is female and the other of the ports is threaded and is male;
one of the ports is unthreaded and is female and the other of the ports is threaded and female;
both of the ports are unthreaded and are male; or,
both of the ports are unthreaded and are female.

21. The sump head of claim 19, wherein:
the inlet port is unthreaded and the outlet port is threaded; or,
the outlet port is unthreaded and the inlet port is threaded.
